(19) United States
(12) Patent Application Publication
(10) Pub. No.: US 2015/0077461 A1
(43) Pub. Date: Mar. 19, 2015

(54) PRINTING COMPENSATION METHOD FOR PRINTING MODULE

(71) Applicant: MICROJET TECHNOLOGY CO., LTD., Hsinchu (TW)

(72) Inventors: Kwo-Yuan Shi, Hsinchu (TW); Hsueh-Kuan Shih, Hsinchu (TW); I-Feng Wu, Hsinchu (TW); Jhih-Hong Lin, Hsinchu (TW)

(21) Appl. No.: 14/468,704

(22) Filed: Aug. 26, 2014

(30) Foreign Application Priority Data
Sep. 13, 2013 (TW) 102133159

(51) Int. Cl. B41J 29/393

(52) U.S. Cl. CPC B41J 29/393; B41J 2029/3935
USPC 347/19

(57) ABSTRACT

A printing compensation method for an inkjet printing system is provided. The inkjet printing system includes a printing module, an image capture module and a dynamic compensation module. The printing module includes plural nozzles. First, a nozzle test pattern corresponding to the plural nozzles is printed out by the printing module. Then, a digital data corresponding to the nozzle test pattern is acquired by the image capture module, and a judging step is performed to judge whether any of the plural nozzles is abnormal according to the digital data. If at least one of the plural nozzles is abnormal, an information about at least one failed-print part corresponding to the at least one nozzle is acquired. Then, the dynamic compensation module is enabled to perform a compensation printing operation according to the information about the at least one failed-print part.

### FIELD OF THE INVENTION

The present invention relates to a printing compensation method, and more particularly to a printing compensation method for a printing module of an inkjet printing system.

### BACKGROUND OF THE INVENTION

As known, an inkjet printing system is easy to operate and is able to print on many kinds of media. Consequently, the inkjet printing system is gradually popular to many people and widely used by many users.

Generally, an inkjet printing system comprises several hundreds or even several thousands of nozzles. The diameters of these nozzles are in micrometer scales. However, after the inkjet printing system has been used for a certain time period, some of the nozzles are possibly clogged or damaged.

Conventionally, some methods for judging whether the nozzles are clogged or damaged were disclosed. For example, after an under-tested print document is compared with a standard print document, the user may visually judge whether the under-tested print document has any failed-printed part. As known, the visual comparison is neither objective nor accurate. Moreover, if the user confirms that some nozzles are clogged or damaged, the user usually replaces the inkjet printing module with a new one. The way of replacing the inkjet printing module is neither user-friendly nor cost-effective. Alternatively, the inkjet printing system is equipped with an additional inkjet printing module. The additional inkjet printing module may increase the cost of the inkjet printing system.

Therefore, there is a need of providing a printing compensation method for an inkjet printing system in order to overcome the above drawbacks.

### SUMMARY OF THE INVENTION

The present invention provides a printing compensation method for an inkjet printing system. If any failed-print part is detected, a dynamic compensation module is enabled to perform a compensation printing operation. Consequently, the quality of the print result is enhanced. Since it is not necessary to replace the inkjet printing module or install an additional inkjet printing module when one or more nozzles are clogged or damaged, the inkjet printing system is more user-friendly and the operating cost is reduced.

In accordance with an aspect of the present invention, there is provided a printing compensation method for an inkjet printing system. The inkjet printing system includes a printing module, an image capture module and a dynamic compensation module. The printing module includes plural nozzles. The printing compensation method includes the following steps. First, a nozzle test pattern corresponding to the plural nozzles is printed out by the printing module. Then, a digital data corresponding to the nozzle test pattern is acquired by the image capture module, and a judging step is performed to judge whether any of the plural nozzles is abnormal according to the digital data. If at least one of the plural nozzles is abnormal, an information about at least one failed-print part corresponding to the at least one nozzle is acquired. Then, the dynamic compensation module is enabled to perform a compensation printing operation according to the information about the at least one failed-print part.

The above contents of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the architecture of an inkjet printing system according to an embodiment of the present invention;

FIG. 2A schematically illustrates a nozzle test pattern printed out by the printing module of the inkjet printing system of the present invention, in which the nozzle test pattern has no failed-print part;

FIG. 2B schematically illustrates a nozzle test pattern printed out by the printing module of the inkjet printing system of the present invention, in which the nozzle test pattern has failed-print parts;

FIG. 3A is a flowchart illustrating a printing compensation method according to an embodiment of the present invention;

FIG. 3B is a flowchart illustrating a printing compensation method according to another embodiment of the present invention, in which the image capture module is a scanning module; and

FIG. 3C is a flowchart illustrating a printing compensation method according to another embodiment of the present invention, in which the image capture module is an optical detecting module.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

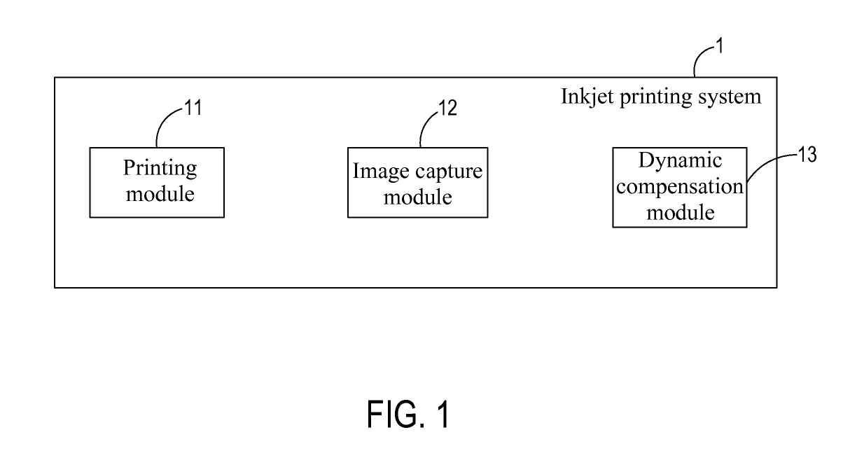

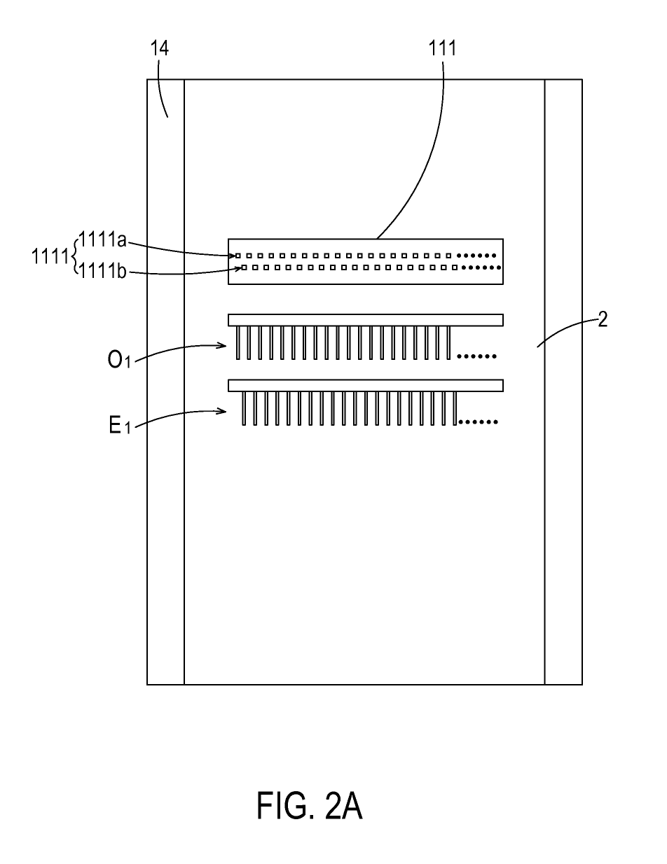

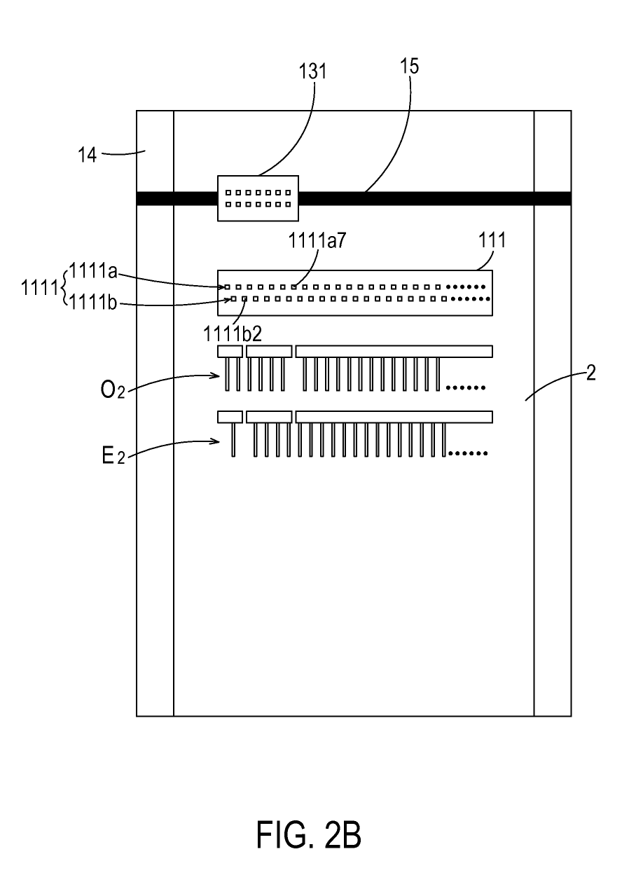

FIG. 1 schematically illustrates the architecture of an inkjet printing system according to an embodiment of the present invention. As shown in FIG. 1, the inkjet printing system 1 comprises a printing module 11, an image capture module 12, and a dynamic compensation module 13. In an embodiment, the printing module 11 is a page-width printing module. The printing module 11 comprises one or more inkjet printing units 111 (see FIGS. 2A and 2B). The inkjet printing unit 111 comprises plural nozzles 1111. The printing module 11 is fixed on a printing platform 14 of the inkjet printing system 1. The printing module 11 is immobile, but a print medium (e.g. a paper) to be printed by the printing module 11 is moved relative to the printing module 11. For testing whether the nozzles of the printing module 11 are normal or not, a nozzle test pattern 2 corresponding to odd-row nozzles 1111a and the even-row nozzles 1111b of the printing module 11 is firstly printed out by the printing module 11.

As shown in FIG. 2B, the dynamic compensation module 13 comprise one or more inkjet printing units 131. Each inkjet printing units 131 is movable back and forth along a fixing mechanism 15. That is, the dynamic compensation module 13 is movable relative to the printing platform 14 in a reciprocating manner. In this embodiment, the moving direction of the inkjet printing unit 131 of the dynamic compensation module 13 is perpendicular to the moving direction of the print medium.

For clarification and brevity, one inkjet printing unit 131 of the dynamic compensation module 13 and one inkjet printing unit 111 of the printing module 11 will be described as follows.

As shown in FIG. 2A, the print result O1 corresponding to the odd-row nozzles and the print result E1 corresponding to the even-row nozzles are successfully and continuously printed out because all nozzles 1111 of the inkjet printing unit 111 are normal.

As shown in FIG. 2B, the print result O2 corresponding to the odd-row nozzles and the print result E2 corresponding to the even-row nozzles are not successfully and continuously printed out because some nozzles are clogged or damaged. For example, the print result O2 of the nozzle test pattern 2 has a failed-print part corresponding to the seventh nozzle 1111a7 of the nozzles 1111a of the inkjet printing unit 111; and the print result E2 of the nozzle test pattern 2 has a failed-print part corresponding to the second nozzle 1111b2 of the even-row nozzles 1111b of the inkjet printing unit 111. In other words, the seventh nozzle 1111a7 of the nozzles 1111a and the second nozzle 1111b2 of the even-row nozzles 1111b are clogged or damaged.

Please refer to FIGS. 1, 2A and 2B again. Then, a digital data corresponding to the nozzle test pattern 2 is acquired by the image capture module 12. An example of the image capture module 12 includes but is not limited to a scanning module or an optical detecting module. After the nozzle test pattern 2 is scanned by the scanning module, a digital data is acquired. According to the digital data, the inkjet printing system 1 may realize whether there is any failed-print part and obtain the information about the failed-print part. Then, the inkjet printing unit 131 of the dynamic compensation module 13 is enabled to perform a compensation printing operation according to the information about the failed-print part. The optical detecting module may detect the print data of the nozzle test pattern 2 corresponding to the plural nozzles 1111 and judge whether the intensities of the reflected light beams are normal or not. If any failed-print part is detected, the information about the failed-print part is acquired. Similarly, the inkjet printing unit 131 of the dynamic compensation module 13 is enabled to perform a compensation printing operation according to the information about the failed-print part.

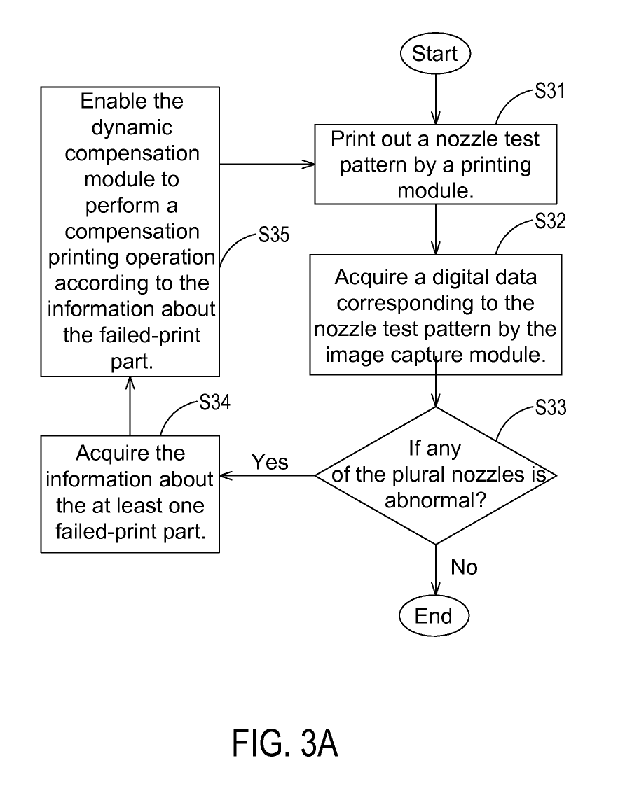

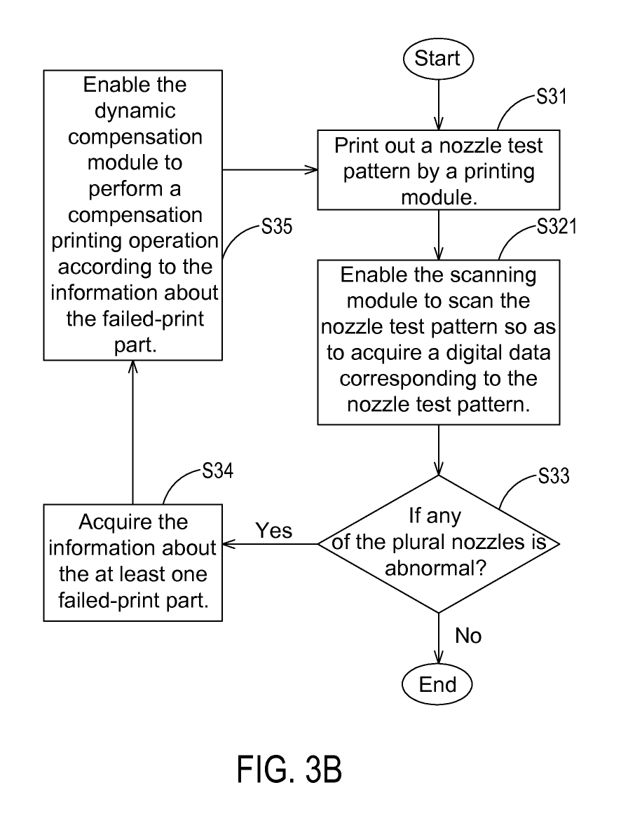

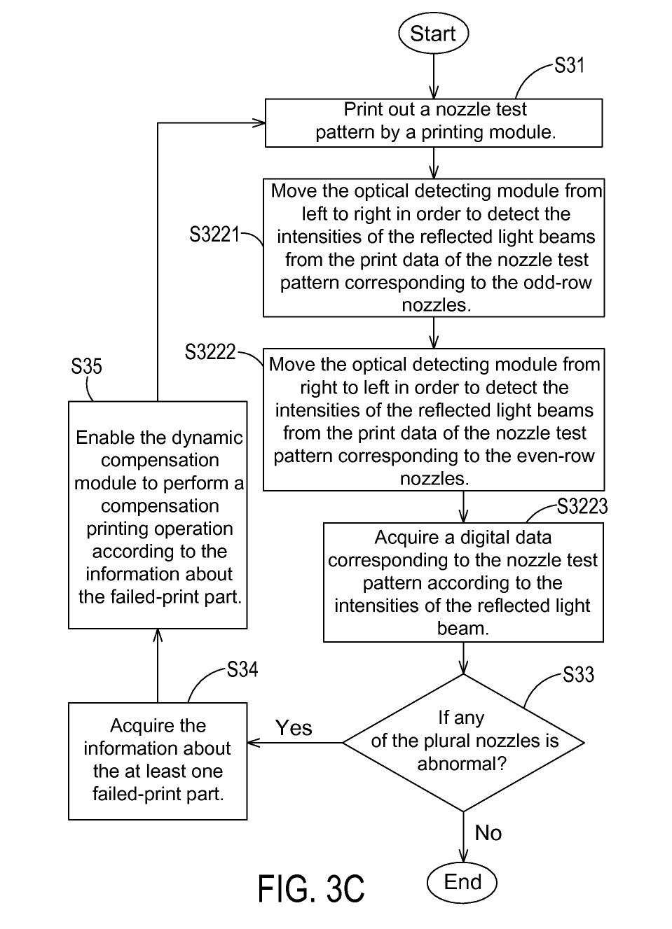

FIG. 3A is a flowchart illustrating printing a compensation method according to an embodiment of the present invention.

Firstly, a nozzle test pattern 2 corresponding to odd-row nozzles 1111a and the even-row nozzles 1111b of the printing module 11 is printed out by the printing module 11 (Step S31). Then, a digital data corresponding to the nozzle test pattern 2 is acquired by the image capture module 12 (Step S32). Then, the step S33 is performed to judge whether any of the plural nozzles 1111 is abnormal according to the digital data.

If the judging condition of the step S33 is not satisfied, it means that the plural nozzles 1111 of the printing module 11 are not clogged or damaged (see FIG. 2A). Under this circumstance, it is not necessary to perform the compensation printing operation. On the other hand, if the judging condition of the step S33 is satisfied, it means that one or more of the plural nozzles 1111 of the printing module 11 are clogged or damaged (see FIG. 2B). Then, the number of the at least one failed-print part and the information about the at least one failed-print part are acquired (Step S34). Then, the dynamic compensation module 13 is enabled to perform a compensation printing operation according to the information about the failed-print part (Step S35). For example, after the compensation printing operation is performed on the print result of FIG. 2B, the print result as shown in FIG. 2A is produced.

In this embodiment, if the compensation printing operation has to be performed, a notification signal is issued to notify the user that the inkjet printing unit 131 of the dynamic compensation module 13 needs to be installed or the inkjet head of the inkjet printing unit needs to be replaced. For example, the notification signal is a flashing light, or the notification signal is a notification message shown on a computer monitor. After the inkjet printing unit 131 of the dynamic compensation module 13 is installed, the dynamic compensation module 13 is moved to desired locations to perform the compensation printing operation. For example, after the dynamic compensation module 13 is moved relative to the printing platform 14 in a reciprocating manner, the print data of the failed-print parts as shown in FIG. 2B are compensated. Consequently, the entire of the print data as shown in FIG. 2A will be printed out by the inkjet printing system 1.

FIG. 3B is a flowchart illustrating a printing compensation method according to another embodiment of the present invention, in which the image capture module is a scanning module. In this embodiment, the image capture module 12 is a scanning module. After the nozzle test pattern 2 is generated by the scanning module (Step S31), the nozzle test pattern 2 is scanned by the scanning module, so that a digital data corresponding to the nozzle test pattern 2 is acquired (Step S321). Then, the step S33 is performed to judge whether any of the plural nozzles 1111 is abnormal according to the digital data. If the judging condition of the step S33 is satisfied, the number of the at least one failed-print part and the information about the at least one failed-print part are acquired (Step S34). Then, the dynamic compensation module 13 is enabled to perform a compensation printing operation according to the information about the failed-print part (Step S35).

FIG. 3C is a flowchart illustrating a printing compensation method according to another embodiment of the present invention, in which the image capture module is an optical detecting module. In this embodiment, the image capture module 12 is an optical detecting module. After the nozzle test pattern 2 is generated by the scanning module (Step S31), the optical detecting module is moved from left to right in order to detect the intensities of the reflected light beams from the print data of the nozzle test pattern 2 corresponding to the odd-row nozzles 1111a (Step S3221). As shown in FIG. 2B, the intensities of the reflected light beams from the print result O2 are detected. Then, the optical detecting module is moved from right to left in order to detect the intensities of the reflected light beams from the print data of the nozzle test pattern 2 corresponding to the even-row nozzles 1111b (Step S3222). As shown in FIG. 2B, the intensities of the reflected light beams from the print result O2 are detected. Then, a digital data corresponding to the nozzle test pattern 2 is acquired by the optical detecting module according to the intensities of the reflected light beams (Step S3223). Then, the step S33 is performed to judge whether any of the plural nozzles 1111 is abnormal according to the digital data. If the judging condition of the step S33 is satisfied, the number of the at least one failed-print part and the information about the at least one failed-print part are acquired (Step S34). Then, the dynamic compensation module 13 is enabled to perform a compensation printing operation according to the information about the failed-print part (Step S35).

From the above descriptions, the present invention provides a printing compensation method for an inkjet printing system. The inkjet printing system comprises a printing module, an image capture module, and a dynamic compensation module. Firstly, a nozzle test pattern is printed out by the printing module. Then, a digital data corresponding to the nozzle test pattern is acquired by the image capture module. If any failed-print part is detected, the information about the failed-print part is acquired. Moreover, the inkjet printing unit of the dynamic compensation module is enabled to perform a compensation printing operation according to the information about the failed-print part. Consequently, the quality of the print result is enhanced. Since it is not necessary to replace the inkjet printing module or install an additional inkjet printing module when one or more nozzles are clogged or damaged, the inkjet printing system is more user-friendly and the operating cost is reduced. Moreover, according to the digital data, the inkjet printing system may realize whether there is any failed-print part and obtain the information about the failed-print part. Consequently, the statuses of the nozzles of the printing module can be realized more objectively and accurately.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A printing compensation method for an inkjet printing system, the inkjet printing system comprising a printing module, an image capture module and a dynamic compensation module, the printing module comprising plural nozzles, the printing compensation method comprising steps of:
(a) printing out a nozzle test pattern corresponding to the plural nozzles by the printing module;
(b) acquiring a digital data corresponding to the nozzle test pattern by the image capture module, and judging whether any of the plural nozzles is abnormal according to the digital data, wherein if at least one of the plural nozzles is abnormal, an information about at least one failed-print part corresponding to the at least one nozzle is acquired; and
(c) enabling the dynamic compensation module to perform a compensation printing operation according to the information about the at least one failed-print part.

2. The printing compensation method according to claim 1, wherein the nozzle test pattern is printed on a print medium by the printing module.

3. The printing compensation method according to claim 2, wherein the printing module is a page-width printing module.

4. The printing compensation method according to claim 3, wherein the printing module comprises at least one inkjet printing unit and the printing module is fixed on a printing platform of the inkjet printing system.

5. The printing compensation method according to claim 4, wherein the dynamic compensation module is movable relative to the printing platform in a reciprocating manner.

6. The printing compensation method according to claim 1, wherein the image capture module is a scanning module, wherein after the nozzle test pattern is scanned by the scanning module, the digital data corresponding to the nozzle test pattern is acquired.

7. The printing compensation method according to claim 1, wherein the image capture module is an optical detecting module, wherein after intensities of reflected light beams from print data of the nozzle test pattern corresponding to odd-row nozzles and even-row nozzles are detected by the optical detecting module, the digital data corresponding to the nozzle test pattern is acquired.
